(19) United States
(12) Patent Application Publication
(10) Pub. No.: US 2017/0140104 A1
(43) Pub. Date: May 18, 2017

(54) APPARATUS AND METHOD FOR GENERATING A PATIENT HEALTH DATA PROFILE

(71) Applicant: OBoard, LLC, McKinney, TX (US)

(72) Inventors: David A. Larson, McKinney, TX (US); David A. Grainger, Wichita, KS (US); Robson L. Parzianello, Pato Branco (BR); Kenneth W. Chapman, Lewisville, TX (US); John M. Harrell, JR., Prescott, AZ (US)

(21) Appl. No.: 15/351,260

(22) Filed: Nov. 14, 2016

Related U.S. Application Data
(60) Provisional application No. 62/254,909, filed on Nov. 13, 2015.

(51) Int. Cl. G06F 19/00

(52) U.S. Cl. CPC G06F 19/322; G06F 19/327; G06F 19/363; G06F 19/3406

(57) ABSTRACT

A healthcare workflow manager may include processing circuitry configured to receive health data relating to a plurality of patients currently admitted or expected to be currently admitted to a healthcare facility and generate a plurality of patient profiles based on the health data, the plurality of patient profiles enabling management of a labor and delivery process of each of the plurality of patients, where each patient profile of the plurality of patient profiles includes a plurality of data categories relating to the labor and delivery process of each of the plurality of patients. The processing circuitry may be even further configured to transmit and cause display of the plurality of patient profiles on a user interface.

### CROSS REFERENCE TO RELATED APPLICATIONS

The present application claims priority to U.S. patent application No. 62/254,909 filed Nov. 13, 2015, the entire contents of which are hereby incorporated by reference.

### TECHNICAL FIELD

Example embodiments generally relate to generating a patient profile based on health data of the patient.

### BACKGROUND

Caregivers in labor and delivery units in hospitals must identify and monitor information relating to a patient and their care. This information may include patient room location, attending physician, and multiple parameters surrounding the patient's medical condition (such as cervical dilation, effacement, and station of baby in birth canal, etc.). Caregivers in hospitals may have to manually write down this information, which leads to inconsistent, unreadable, error prone information. Moreover, the parameters of the labor and delivery process such as cervical dilation, effacement, and station of baby in birth canal, for example, are constantly changing. Therefore, this information may be written down and changed (i.e., erased) as the parameters change. Because data relating to the patient's labor and delivery process (cervical dilation, effacement, and station of baby in birth canal) may not be stored, the data relating to labor and delivery is incapable of being used in analytics relating to improving the labor and delivery process. Notably, the electronic medical record systems of hospitals and healthcare facilities are focused on support of back-office operations (e.g., insurance, billing, etc.) of the hospitals and healthcare facilities and development of a legal patient medical record.

### BRIEF SUMMARY OF SOME EXAMPLES

An example embodiment may provide a healthcare workflow manager that includes processing circuitry. The processing circuitry may be configured to receive health data relating to a plurality of patients currently admitted or expected to be currently admitted to a healthcare facility. The processing circuitry may be further configured to generate a plurality of patient profiles based on the health data, the plurality of patient profiles enabling management of a labor and delivery process of each of the plurality of patients, where each patient profile of the plurality of patient profiles includes a plurality of data categories relating to the labor and delivery process of each of the plurality of patients. The processing circuitry may be even further configured to transmit and cause display of the plurality of patient profiles on a user interface.

In an example embodiment, a method may be provided. The method may include receiving health data relating to a plurality of patients currently admitted or expected to be currently admitted to a healthcare facility. The method may further include generating a plurality of patient profiles based on the health data, the plurality of patient profiles enabling management of a labor and delivery process of each of the plurality of patients, where each patient profile of the plurality of patient profiles includes a plurality of data categories relating to the labor and delivery process of each of the plurality of patients. The method may even further include transmitting and causing display of the plurality of patient profiles on a user interface.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of a system in which a healthcare workflow manager may be employed in accordance with an example embodiment;

FIG. 2 illustrates a block diagram of a healthcare workflow manager in accordance with an example embodiment;

FIG. 3 illustrates a representative (global) view of the healthcare facility profile generated by healthcare workflow manager that may be displayed on a user interface in accordance with an example embodiment;

FIGS. 4-6 illustrate representative views of the user interface generated by the healthcare workflow manager in response to a user selecting a category in accordance with example embodiments;

FIG. 7 illustrates a representative view of the healthcare facility profile generated by healthcare workflow manager that may be displayed on a user interface in accordance with a further example embodiment;

FIG. 8 illustrates a representative view of the user interface generated by the healthcare workflow manager in response to the user selecting the handoff option in accordance with an example embodiment;

FIGS. 9-11 illustrate representative views of the patient profile generated by the healthcare workflow manager that may be displayed on a user interface in accordance with example embodiments;

FIG. 12 illustrates a representative individual patient view of the user interface generated by the healthcare workflow manager in response to a user selecting a category in accordance with an example embodiment; and

FIG. 13 illustrates a block diagram of a method in accordance with a further example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

In a healthcare facility, many sources may capture data related to a patient's health. These sources may include various sensors such as medical biofeedback sensors (e.g., maternal and fetal heart rate monitors), thermometers, clocks, scales, or the like. The sources may further include administrative records and systems such as electronic medical records (EMR), human resource and personnel records, logistic and scheduling systems, or the like. The sources may further include employees of the healthcare facility (i.e., healthcare professionals), where the employees manually capture information relating to the patient's health. Accordingly, a healthcare workflow manager may be provided to capture the data related to a patient's health from the healthcare professionals and systems and sensors in order to generate a patient profile for viewing by a healthcare professional. The patient profile may be an aggregate view of the patient's health data such that the healthcare professional may have a more comprehensive and cumulative look at the patient's health care data and history rather than only being able to view data from a last examination of the patient or the like. Additionally, the patient profile may be configured to be displayed and updated on a device or any number of devices including the mobile device of the healthcare professional. Accordingly, the healthcare professional does not have to leave their current work area to view or enter data relating to the patient profile. Thus, the generation of the patient profile via the healthcare workflow manager results in: 1) less effort and time expended by the healthcare professional (i.e., increase in work satisfaction); 2) more active bedside medical care time (i.e., improved care for patients); and 3) improved patient satisfaction. Moreover, even after the patient has been discharged from the healthcare facility, the data associated with the patient profile may be archived and analyzed by the healthcare workflow manager to improve the quality and level of care given by the healthcare facility, assist in future patient visits or the recovery of the patient, or for audit, research, regulatory, (re) certification, and process efficiency and/or quality review, compliance, and improvement analysis.

Additionally, based on the patient profile generated by the healthcare workflow manager, the healthcare workflow manager may be further enabled to generate alerts, notifications, alarms, outcomes, tasks, events, tests, or charts related to the patient's health for viewing by the healthcare professional. Accordingly, in order to enable healthcare professionals to effectively manage the active labor and delivery process for patients and to archive the data associated with the labor and delivery process for future evaluation and analysis, a healthcare workflow manager may receive, monitor, and evaluate healthcare data relating to the patient from a plurality of sources in order to generate a patient profile. Thus, the healthcare workflow manager contained herein allows users access to labor and delivery data on a number of devices, whenever and wherever the healthcare provider may be.

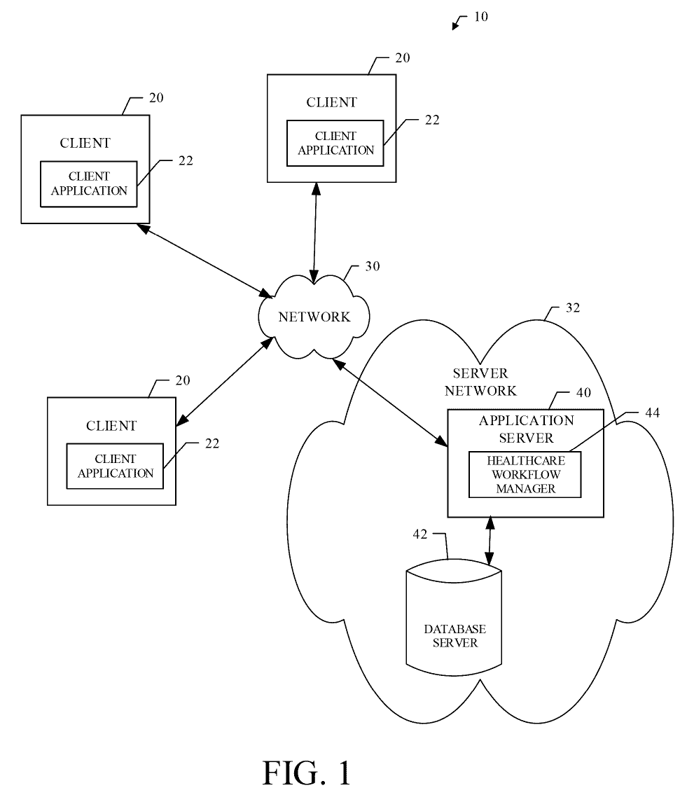

FIG. 1 illustrates an example system in which a healthcare workflow manager 44 may be employed. As shown in FIG. 1, a system 10 according to an example embodiment may include one or more client devices (e.g., clients 20). Notably, although FIG. 1 illustrates three clients 20, it should be appreciated that the number of clients 20 is in no way limiting to further example embodiments.

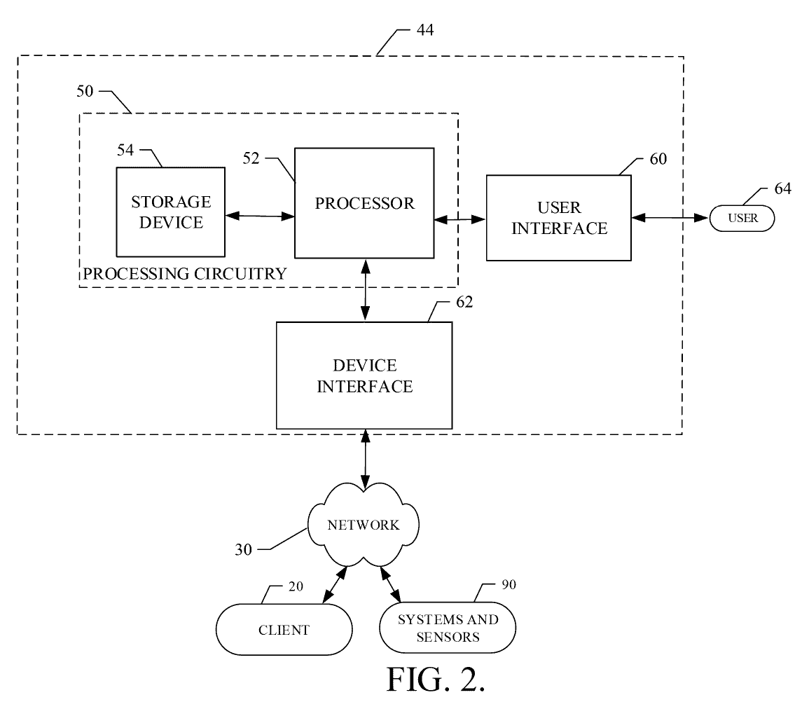

The example embodiment described herein relates to a client 20 comprising a mobile computing device. However, it should be appreciated that further example embodiments may apply to any asset including, for example, any programmable device that is configured to provide a recommended action to a user (e.g., user of FIG. 2) based on information corresponding to the user and at least one product in a virtual product library, as described herein.

Each one of the clients 20 may include or otherwise be embodied as computing device (e.g., a computer, smart board, a network access terminal, a personal digital assistant (PDA), iPad, cellular phone, smart phone, smart watch, or the like) capable of communication with a network 30. As such, for example, each of the clients 20 may include (or otherwise have access to) memory for storing instructions or applications for the performance of various functions and a corresponding processor for executing stored instructions or applications. Each of the clients 20 may also include software or corresponding hardware for enabling the performance of the respective functions of the clients 20 as described below. In an example embodiment, one or more of the clients 20 may include a client application 22 configured to operate in accordance with an example embodiment. In this regard, for example, the client application 22 may include software for enabling a respective one of the clients 20 to communicate with the network 30 for requesting or receiving information or services via the network 30. Moreover, in some embodiments, the information or services that are requested via the network may be provided in a software as a service (SAS) environment. The information or services receivable at the client applications 22 may include deliverable components (e.g., downloadable software to configure the clients 20, or information for consumption/processing at the clients 20). As such, for example, the client application 22 may include corresponding executable instructions for configuring the client 20 to provide corresponding functionalities for monitoring a patient profile and providing a recommended action to the user 64, as described herein.

The network 30 may be a data network, such as a local area network (LAN), a metropolitan area network (MAN), a wide area network (WAN) (e.g., the Internet), or the like, which may couple the clients 20 to devices such as processing elements (e.g., personal computers, server computers, or the like) or databases. Communication between the network 30, the clients 20, and the devices or databases (e.g., servers) to which the clients 20 are coupled may be accomplished by both wired or wireless communication mechanisms and corresponding communication protocols.

In an example embodiment, devices to which the clients 20 may be coupled via the network 30 may include one or more application servers (e.g., application server 40), or a database server 42, which together may form respective elements of a server network 32. Although the application server 40 and the database server 42 are each referred to as “servers,” this does not necessarily imply that the application server 40 and the database server 42 are on separate servers or devices. As such, for example, a single server or device may include both the application server 40 and the database server 42, and the database server 42 could merely be represented by a database or group of databases physically located on the same server or device as the application server 40. The application server 40 and the database server 42 may each include hardware or software for configuring the application server 40 and the database server 42, respectively, to perform various functions. As such, for example, the application server 40 may include processing logic and memory enabling the application server 40 to access or execute stored computer readable instructions for performing various functions. In an example embodiment, one function that may be provided by the application server 40 may be the provision of access to information or services related to operation of the clients 20. For example, the application server 40 may be configured to provide for storage of information descriptive of motion or location. In some cases, these contents may be stored in the database server 42. Alternatively or additionally, the application server 40 may be configured to provide analytical tools for use by the clients 20 in accordance with example embodiments.

In some embodiments, for example, the application server 40 may, therefore, include an instance of the healthcare workflow manager 44 comprising stored instructions for handling activities associated with example embodiments described herein. As such, in some embodiments, the clients 20 may access the healthcare workflow manager 44 online and utilize the services provided thereby. However, it should be appreciated that in other embodiments, the healthcare workflow manager 44 may be initiated from an integrated memory of the client 20. In some example embodiments, the healthcare workflow manager 44 may be provided from the application server 40 (e.g., via download over the network 30) to one or more of the clients 20 to enable recipient clients to instantiate an instance of the healthcare workflow manager 44. As yet another example, the healthcare workflow manager 44 may be instantiated at one or more of the clients 20 responsive to downloading instructions from a removable or transferable memory device carrying instructions for instantiating the healthcare workflow manager 44 at the corresponding one or more of the clients 20. In such an example, the network 30 may, for example, be a peer-to-peer (P2P) network where one of the clients 20 includes an instance of the healthcare workflow manager 44 to enable the corresponding one of the clients 20 to act as a server to other clients 20. In a further example embodiment, healthcare workflow manager 44 may be distributed amongst one or more clients 20 or the application server 40.

In an example embodiment, the application server 40 may include or have access to memory (e.g., internal memory or the database server 42) for storing instructions or applications for the performance of various functions and a corresponding processor for executing stored instructions or applications. For example, the memory may store an instance of healthcare workflow manager 44 configured to operate in accordance with example embodiments described herein. In this regard, for example, the healthcare workflow manager 44 may include software for enabling the application server 40 to communicate with the network 30 or the clients 20 for the provision or receipt of information associated with performing activities as described herein. Moreover, in some embodiments, the application server 40 may include or otherwise be in communication with an access terminal (e.g., a computer including a user interface) via which analysts may interact with, configure, or otherwise use to maintain the system 10.

FIG. 2 illustrates a block diagram of a healthcare workflow manager 44 in accordance with an example embodiment. The healthcare workflow manager 44 may be employed, for example, on a client (e.g., any of the clients 20 of FIG. 1) or a variety of other devices (such as, for example, a network device, server, proxy, or the like (e.g., the application server 40 of FIG. 1)). Additionally or alternatively, embodiments may be employed on a combination of devices. Accordingly, some example embodiments may be embodied wholly at a single device (e.g., the application server 40 or one or more clients 20) or by devices in a client/server relationship (e.g., the application server 40 and one or more clients 20). Furthermore, it should be noted that the devices or elements described below may not be mandatory and thus some may be omitted in certain embodiments.

As shown in FIG. 2, a healthcare workflow manager 44 is provided that may be configured to receive and monitor the healthcare data of a patient in order to generate a patient profile as well as a global view of all patients in the healthcare facility. The healthcare workflow manager 44 may receive health care data from a plurality of sources, including manual user input via the client device 20 and systems and sensors 90 (e.g., EMR systems, thermometers, blood pressure monitors, fetal and maternal heart monitors, contraction monitor, or the like) in order to generate a patient profile. Based on the patient profile, the healthcare workflow manager 44 may provide recommended actions and generate charts for the user 64 (where the user 64 may be a healthcare professional that corresponds to or uses one of the clients 20). In an example embodiment, the healthcare workflow manager 44 may include or otherwise be in communication with processing circuitry 50 that is configured to perform data processing, application execution, and other processing and management services. In one example embodiment, the processing circuitry 50 may include a storage device 54 and a processor 52 that may be in communication with or otherwise control a user interface 60 and a device interface 62. As such, the processing circuitry 50 may be embodied as a circuit chip (e.g., an integrated circuit chip) configured (e.g., with hardware, software, or a combination of hardware and software) to perform operations described herein. However, in further example embodiments, the processing circuitry 50 may be embodied as a portion of a server, computer, laptop, cell phone, or workstation. In situations where the processing circuitry 50 is embodied at a server or at a remotely located computing device, the user interface 60 may be disposed at another device (e.g., at a computer terminal or client device such as one of the clients 20) that may be in communication with the processing circuitry 50 via the device interface 62 or a network (e.g., network 30).

The user interface 60 may be in communication with the processing circuitry 50 to receive an indication of a user input at the user interface 60 or to provide an audible, visual, mechanical or other output to the user 64. As such, the user interface 60 may include, for example, a keyboard, a mouse, a joystick, a display, a touch screen, a microphone, a speaker, a cell phone, or other input/output mechanisms. In embodiments where the healthcare workflow manager 44 is embodied at a server or other network entity, the user interface 60 may be limited. Alternatively, as indicated above, the user interface 60 may be remotely located.

The device interface 62 may include one or more interface mechanisms for enabling communication with other devices or networks. In some cases, the device interface 62 may be any means such as a device or circuitry embodied in either hardware, software, or a combination of hardware and software that is configured to receive or transmit data from/to a network or any other device or module in communication with the processing circuitry 50. In this regard, the device interface 62 may include, for example, an antenna (or multiple antennas) and supporting hardware, software for enabling communications with a wireless communication network, or a communication modem or other hardware/software for supporting communication via cable, digital subscriber line (DSL), universal serial bus (USB), Ethernet, or other methods. In situations where the device interface 62 communicates with a network, the network may be any of various examples of wireless or wired communication networks such as, for example, data networks like a Local Area Network (LAN), a Metropolitan Area Network (MAN), or a Wide Area Network (WAN), such as the Internet.

In an example embodiment, the storage device 54 may include one or more non-transitory storage or memory devices such as, for example, volatile or non-volatile memory that may be either fixed or removable. The storage device 54 may be configured to store information, data, applications, instructions or the like for enabling the healthcare workflow manager 44 to carry out various functions in accordance with example embodiments. For example, the storage device 54 could be configured to buffer input data for processing by the processor 52. Additionally or alternatively, the storage device 54 could be configured to store instructions for execution by the processor 52. In a further example embodiment, the storage device 54 may include one of a plurality of databases (e.g., database server 42) that may store a variety of files, contents, or data sets. Among the contents of the storage device 54, applications (e.g., client application 22 or service application 42) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to example embodiments. Thus, for example, when the processor 52 is embodied as an ASIC, FPGA, or the like, the processor 52 may be specifically configured hardware for conducting the operations described herein. Alternatively, when the processor 52 is embodied as an executor of software instructions, the instructions may specifically configure the processor 52 to perform the operations described herein.

In an example embodiment, the processor 52 (or the processing circuitry 50) may be embodied as, include, or otherwise control the healthcare workflow manager 44, which may be any means, such as, a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the healthcare workflow manager 44 as described below.

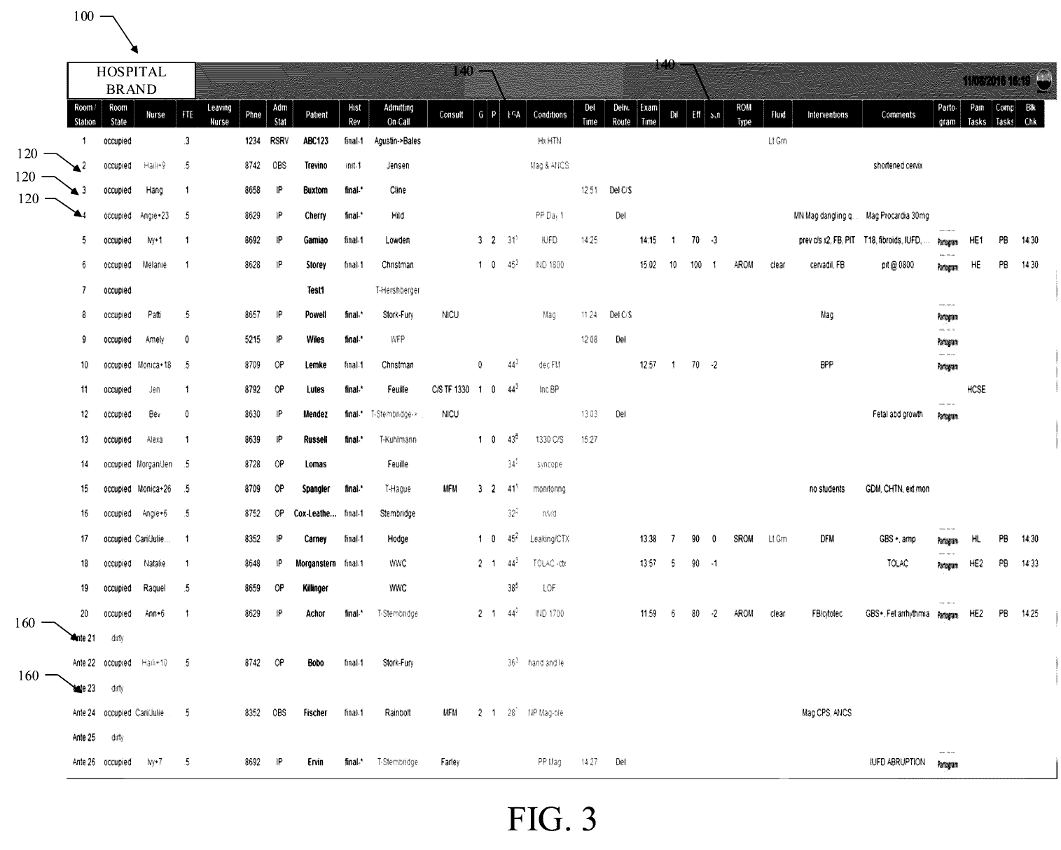

Upon the patient being admitted into a labor and delivery unit of the healthcare facility, the healthcare workflow manager 44 may be configured to begin receiving health data relating to a patient from the client 20 and the systems and sensors 90 in order to initially populate a patient profile 120 (see FIG. 3) for the patient. Example embodiments described herein are described in relation to the labor and delivery unit of a health care, however, it should be understood that the example embodiments may apply to other units of healthcare facility. The data initially received from the systems and sensors 90 (e.g., EMR system) may include data associated with the prenatal visits or general medical history of the patient. For example, the data may include the patient's weight and blood pressure and last position of baby, etc. Upon receiving data relating to the patient, the healthcare workflow manager may be configured to generate a patient profile 120 (see FIG. 3) for the patient based on the initial data received. The patent profile 120 generated by the healthcare workflow manager 44 may be continually updated via the healthcare workflow manager 44 or automatically from other systems and sensors 90 during the duration of the patient's stay in the labor and delivery unit of the healthcare facility.

Each patient profile 120 generated via the healthcare workflow manager 44 may be populated, over the duration of the patient's treatment in the labor and delivery unit, with the following general types of data: logistics and delivery of care. In some example embodiments, the logistics data may include nurse assignments, physician responsibilities, and transitions of care. In some cases, the nurse assignment data may include, for example, the following data categories: patient room assignment, nurse assignment, and patient acuity. Additionally, the physician responsibilities may include, for example, the following data categories: first, second, and third level call and in-house call. Furthermore, the transitions of care data may include, for example, the following data categories: on-call doctor, attending doctor, attending nurse, and anesthesia.

In accordance with other example embodiments contained herein, the delivery of care data may include key patient physical and medical history data, delivery progress, conditions, interventions, reminders, and anesthesia actions. The key patient history data may include, for example, the following data categories for a labor and delivery unit: number of previous pregnancies (G), number of successful deliveries (P), estimate gestational age (EGA), membrane status, fluid observation if membrane has been ruptured, and number of previous caesarian sections, medical conditions, and interventions. In some cases, the delivery progress may include, for example, the following data categories: presentation, dilation, effacement, station, position, and Bishop Score information. Moreover, the interventions data may include, for example, the following data categories or types of medical interventions: 1) procedures such as, AROM (Artificial Rupture of Membrane), DFM (Direct Fetal Monitor), IUPC (Intrauterine Pressure Catheter); 2) medications such as, Pit (Pitocin), Mag (Magnesium Sulfate), ANCS (Antenatal Corticosteroids); 3) lab tests such as, PIH (Pregnancy Induced Hypertension), GBS (Group B Streptococcus), OGCT (Oral Glucose Challenge Test); or 4) image diagnostics such as MRI (Magnetic Resonance Imaging), CXR (Chest X-Ray), Soon (Complete or Limited Sonogram), ECHO (Fetal Echocardiogram). Additionally, the reminders data may include, for example, the following data categories: cervical examinations, monitor blood pressure, and call attending physician. The anesthesia data may include, for example, the following data categories: pain management history, planned pain management, spinal epidural pain block placed, block checked, and catheter removed.

The patent profile 120 generated by the healthcare workflow manager 44 may be updated via the healthcare workflow manager 44 with the logistics and delivery of care data described above in response to receiving this logistics and delivery of care data from either the systems and sensors 90, manual user input, or automatically via the healthcare workflow manager 44 based on predefined criteria.

Each of the patient profiles 120 generated by the healthcare workflow manager 44 may be used to generate a global healthcare facility profile 100 (see FIG. 3). This healthcare facility profile 100 may enable a user to view of all patients currently being treated in the labor delivery unit. Moreover, the healthcare workflow manager 44 may be configured to receive data relating to healthcare facility (e.g. room lists, staff schedules, etc.). Thus, the healthcare facility profile 100 may include an aggregated view of a plurality of patient profiles 120 associated with the patients currently admitted or expected to be admitted in the labor and delivery unit of the healthcare facility along with relevant healthcare facility data, as described below. FIG. 3 illustrates an example embodiment of the healthcare facility profile 100 generated by healthcare workflow manager 44 that may be displayed on a user interface 60. As shown in FIG. 3, the healthcare facility profile 100 may include the patient profiles 120 of each patient currently admitted into the labor and delivery unit of the healthcare facility. In accordance with example embodiment contained herein, the healthcare workflow manager 44 may cause each patient profile 120 to be listed as an individual, single row across a portion of the user interface 60.

Each patient profile 120 may include a plurality of categories 140 corresponding to the logistics and delivery of care data types explained above. The healthcare workflow manager 44 may cause the categories 140 to be displayed across a top portion of the user interface 60 as columns thereby causing each patient profile 120 to be broken down by columns into a plurality of categories. It should be understood that the categories that the healthcare workflow manager 44 is configured to populate or update may be customizable by the user 64. Therefore, in accordance with example embodiments contained herein, the patient profile 120 may contain more or less categories, in different ordering or sequencing, depending on the preferred configuration of the user 64.

In accordance with example embodiments contained herein, each patient profile 120 may include, for example, the following data categories 140: room/station number, room state, assigned nurse, number of patients assigned to each nurse based on acuity using full-time equivalents (FTE), phone number assigned to room, admission status; (e.g., example, In-Patient (IP), meaning the patient is part of the billing system, Out-Patient (OP), meaning the patient is being observed but not part of the billing system yet, Reserved (RSRV), meaning a critical patient will be transferred from a lower level care facility), patient name, medical history and physical exam obtained by what level (meaning a medical student may have taken the exam but the exam, is not “official” until the resident or attending physician has reviewed the exam), admitting on-physician, consulting physician, number of previous pregnancies (G), number of successful deliveries (P), estimate gestational age (EGA), medical conditions, delivery time, delivery route (e.g., caesarean section or vaginal delivery), last examination time, dilation, effacement, fetal station, rupture of membrane (ROM) type, fluid observations, interventions, general comments, room location, assigned nurse, or the like.

Each of the data categories 140 may be individually selectable by the user 64 in order to view or update the data associated with the category 140 (as further described below). In some cases, upon selection of the category, the data associated with a category 140 may be updated manually by the user from pop-up forms, drop-down options, or text formats. In other cases, however, the data associate with the category 140 may be updated automatically based on the data received from the systems and sensors 90 or predefined criteria.

As further shown in FIG. 3, the healthcare facility profile 100 may not only include the patient profiles 120 of each patient currently admitted into the labor and delivery unit of the healthcare facility but also include a room listing 160 of each room in the labor and delivery unit and the room's status (e.g., occupied, dirty, ready for occupancy, or the like). It should be understood that in some cases the room listing 160 and status may form part of the patient profile 120. In other cases, however, the room listing 160 and the associated status may be listed in the healthcare facility profile 100 for informational purposes, such as for determining what rooms are available for new patients, scheduling, etc. The room listing 160 and status in the healthcare workflow manager 44 may be manually entered and updated. In other example embodiments, however, the status of the room listing 160 may be automatically updated in response to predefined criteria. For example, upon the healthcare workflow manager 44 receiving data that indicates discharge of the patient, the healthcare workflow manager 44 may be automatically configured to change the status of the room listing 160 to dirty. Moreover, upon the healthcare workflow manager 44 receiving data that is indicative of a new patient, the healthcare workflow manager 44 may be automatically configured to assign the patient a room and change the status of the room listing 160 to occupied. Further, the healthcare workflow manager 44 may be configured to update the room listing 160 associated with the patient profile 120. For example, if the patient is moved to a different room, the healthcare workflow manager 44 may be configured to provide the updated room listing 140. In some cases, the healthcare workflow manager 44 may update the room listing 160 automatically in response to receiving data that indicates a room change (e.g., an RFID device indicates the patient is located in a different room or the like). Additionally, the healthcare workflow manager 44 may also update the room listing in response to receiving manual user input.

In other example embodiments, in generating the healthcare facility profile 100, the healthcare workflow manager 44 may be configured to receive data regarding who is currently working or staffed in the labor and delivery unit. This staffing data may be automatically received via the use of employee badges, key fobs, log-in passwords, personnel records, work schedules, cameras, biometric readers, and any other source that holds information about people employed in the labor and delivery unit. Based on receiving the staffing data, the healthcare workflow manager 44 may be configured to assign available nurses to new patients or the like.

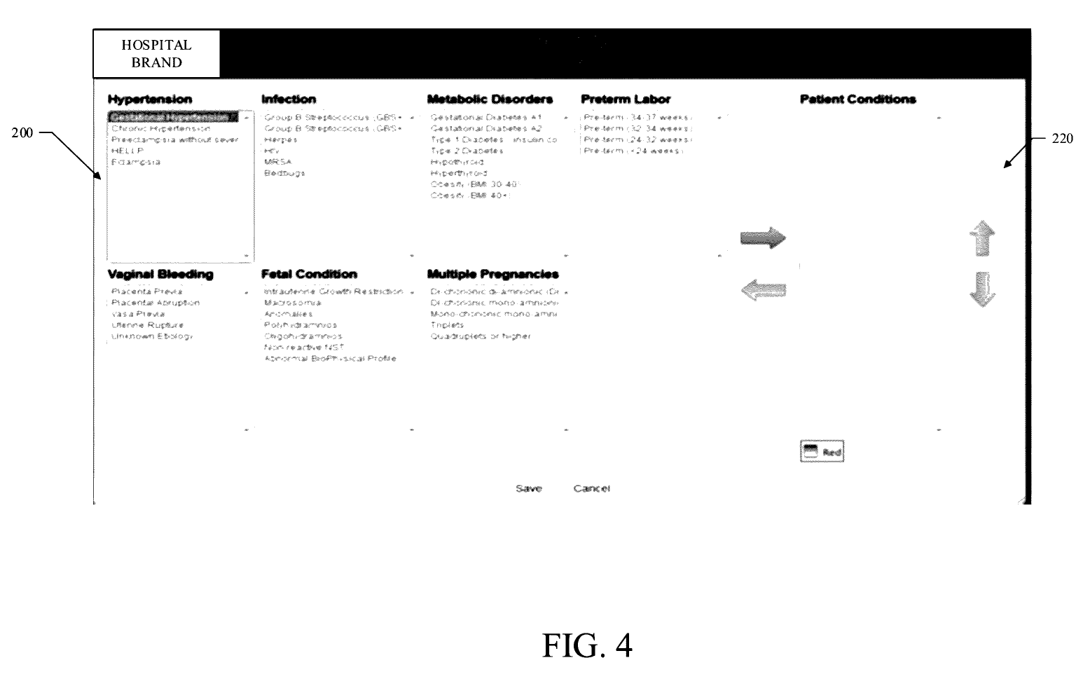

As mentioned above, each category 140 of the patient profile 120 may be selectable by the user 64. FIG. 4 illustrates an example embodiment of the user interface generated in response to the user 64 selecting a category 140. As shown in FIG. 4, in response to the user 64 selecting the category 140 titled “conditions”, the healthcare workflow manager 44 may cause the generation of a plurality of predefined conditions for the user 64 to select and interact with. For example, as shown in FIG. 4, the healthcare workflow manager 44 may cause a plurality of predefined conditions to generate on a first portion 200 of the user interface. These predefined conditions may include, for example, hypertension, vaginal bleeding, infection, fetal condition, metabolic disorders, multiple pregnancies, preterm labor, or the like. For example, if the user 64 observes that the client is experiencing pre-term labor, the user may select the category 140 titled “condition” and then select the appropriate preterm labor condition. By generating pre-defined options, the healthcare workflow manager 44 enables the healthcare professional to improve their speed, accuracy, completeness, and consistency of data input. This results in the following: less chance of entering errors; formalized critical thinking from following known decision-tree options; and increased ability to analyze data consistently over-time and between facilities.

In response to the user 64 selecting the appropriate preterm labor condition, a confirmation of the selection may appear on a second portion 220 of the user interface 60. It should be understood that, in response to user observation, the user 64 may select conditions relating to a hypertension condition, an infection condition, a metabolic disorder condition, a preterm labor condition, a vaginal bleeding condition, a fetal condition, multiple pregnancies condition, or the like. Accordingly, any condition selected by the user 64 may appear on the second portion 220 of the user interface 60. Once the condition appears in the second portion 220 of the user interface 60, the user 64 may reorder the conditions in order of importance, color code the conditions in terms of importance, or the like. After the user 64 has verified the appropriate conditions have been selected and ordered as desired, the user 64 may save the selections and the patient profile 120 may be updated via the healthcare workflow manager 44.

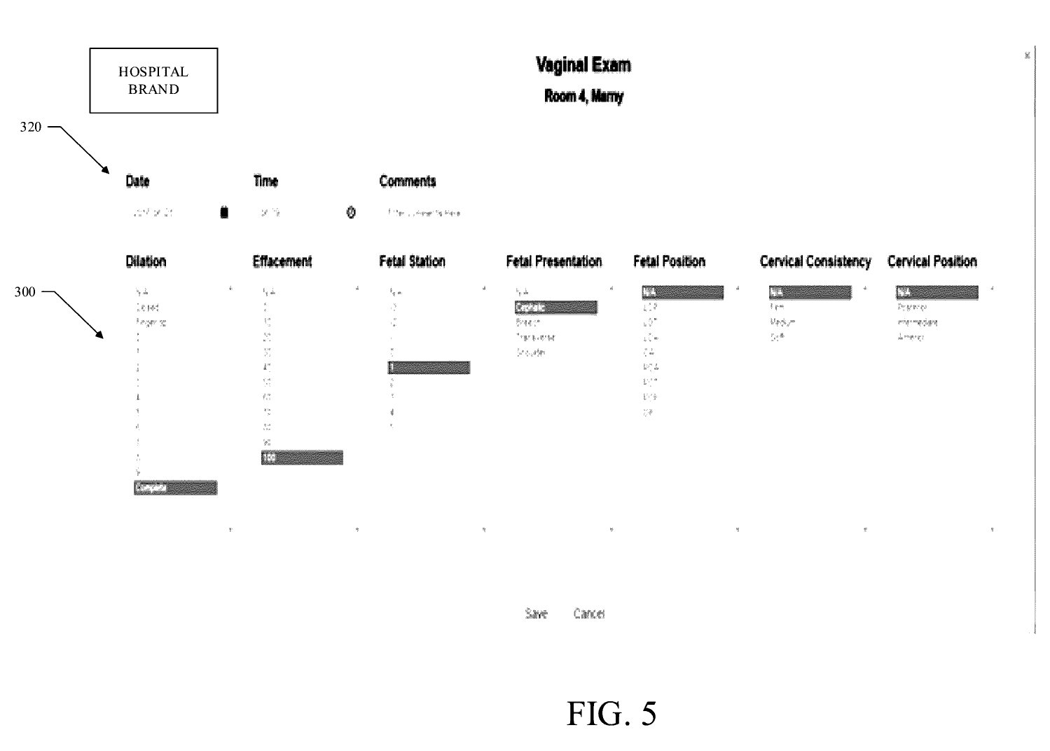

FIG. 5 illustrates an example embodiment of the user interface 60 generated in response to the user 64 selecting a category 140 such as any of the “dilation”, “effacement”, or “fetal station”. Upon selection of one of the categories 140, the healthcare workflow manager 44 may generate a plurality of predefined options for the user 64 to select in regards to the dilation, effacement, and fetal station. The predefined options for selection by the user 64 may be generated on a first portion 300 of the user interface 60. Moreover, in response to the user 64 selecting one of the predefined options (e.g., dilation), the healthcare workflow manager 44 may be configured to automatically populate at least one of the other predefined options relating to the dilation, effacement, and fetal station. For example, if the user 64 selects dilation as complete, the healthcare workflow manager 44 may automatically update the effacement to 100. In other example embodiments, the healthcare workflow manager 44 may be configured such that the conditions that do not change very often automatically populate from the prior cervical examination. For example, fetal position, cervical consistency, and cervical position do not often change during the labor and delivery process so the healthcare workflow manager may be configured to automatically populate the data from the last exam unless the option is selected by the user 64 to be manually updated.

As further shown in FIG. 5, a second portion 320 of the user interface 60 may include a date, time, and comment option. The comment option of the second portion 320 may ensure that the user 64 can note anything not covered by the predefined options of the first portion 300. This ensures that the user 64 is provide flexibility to address the needs and realities of the actual labor and delivery process and results in improved accuracy and completeness of the patient profile 120. Moreover, in accordance with some example embodiments, in response to the user selecting one of the predefined options relating to the dilation, effacement, or fetal station, the date and time may be automatically populated via the healthcare workflow manager 44. After the user 64 has verified the appropriate selections have been made, the user may save the selections and the patient profile 120 may be updated by the healthcare workflow manager 44.

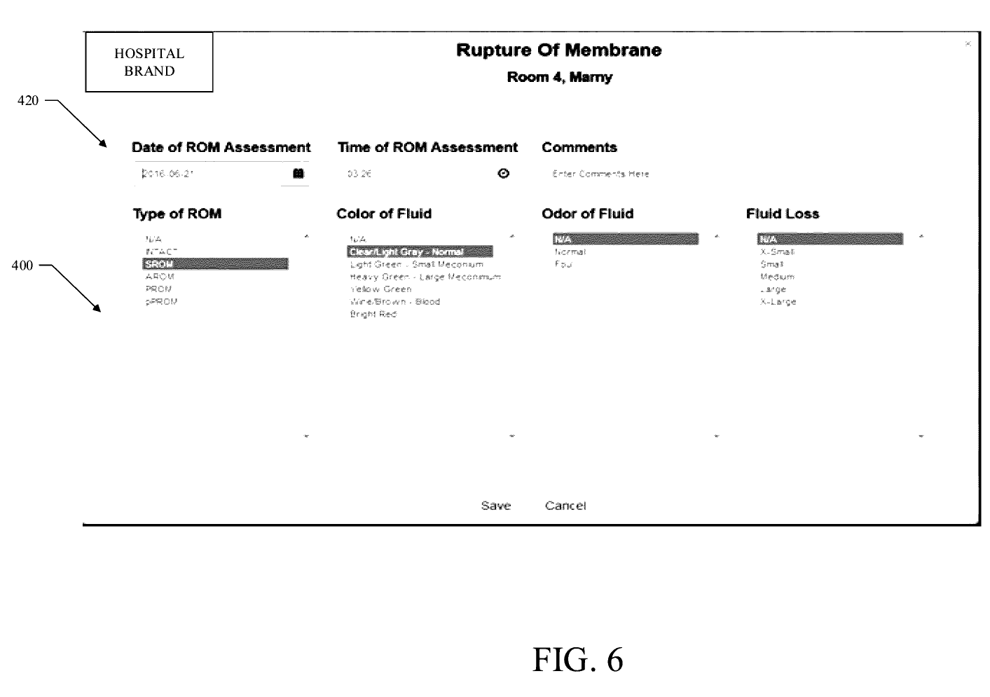

FIG. 6 illustrates an example embodiment of the user interface 60 generated in response to the user selecting a category 140 such as “ROM”. Upon selecting the category 140 of ROM, the healthcare workflow manager 44 may generate a plurality of predefined options for the user 64 to select relating to the type of ROM, the color of fluid, the odor of fluid, and fluid loss. These plurality of options may be generated on a first portion 400 of the user interface 60. Moreover, in response to the user 64 selecting of the predefined options (e.g., type of ROM), the healthcare workflow manager 44 may be configured to automatically populate at least some of the other predefined options. For example, if the user 64 selects the type of ROM as intact, the healthcare workflow manager 44 may automatically update the color of fluid and the odor of fluid option as n/a.

As further shown in FIG. 6, a second portion 420 of the user interface 60 may include a date, time, and comment option. In accordance with some example embodiments, in response to the user 64 selecting one of the predefined options relating to the ROM, the date and time may be automatically populated via the healthcare workflow manager 44. After the user 64 has verified the appropriate selections have been made, the user may save the selections and the patient profile 120 may be updated by the healthcare workflow manager 44.

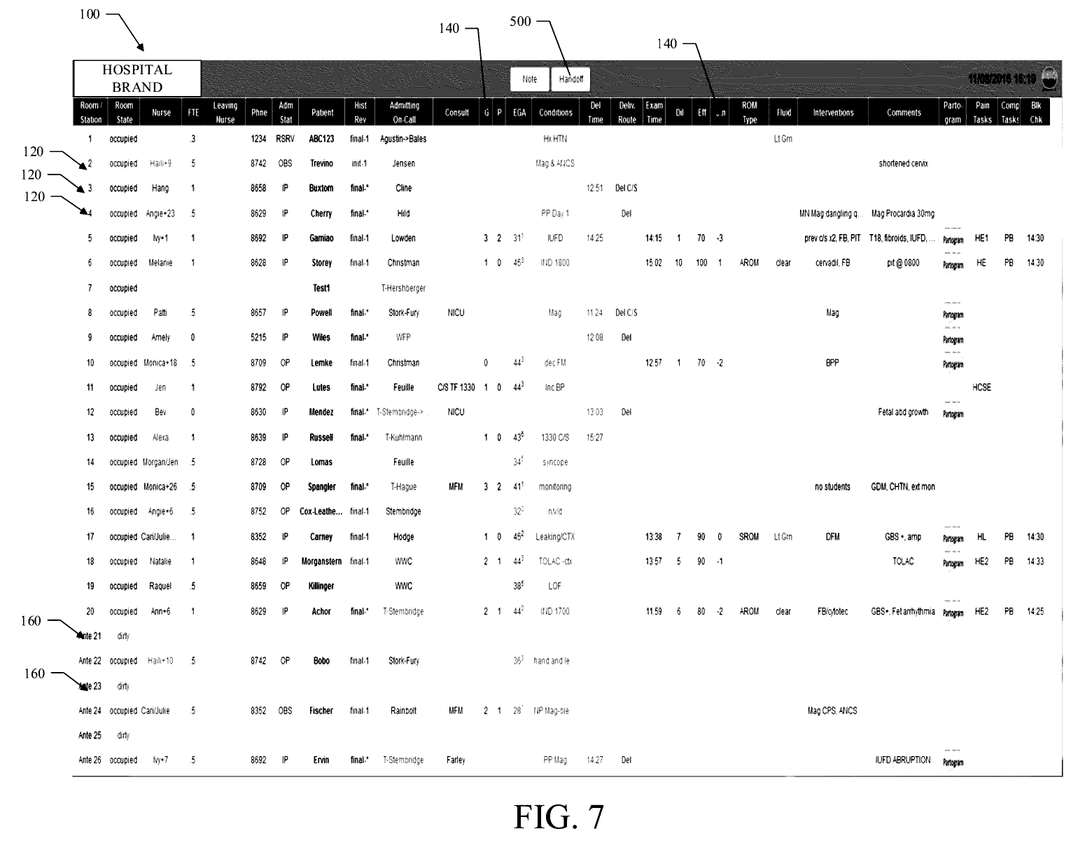

FIG. 7 illustrates an example of the healthcare facility profile in accordance with other example embodiments contained herein. The healthcare workflow manager 44 may be also be configured to facilitate effective and efficient transition between staff of the labor and delivery unit. As shown in FIG. 7, in order to facilitate transitions between staff, the healthcare facility profile 100 generated by the healthcare workflow manager 44 may include also include a handoff option 500. The handoff option 500 may allow the staff transitioning to care to display, update, and document the patient profiles 120 in order to systematically review all patients that will be under their care.

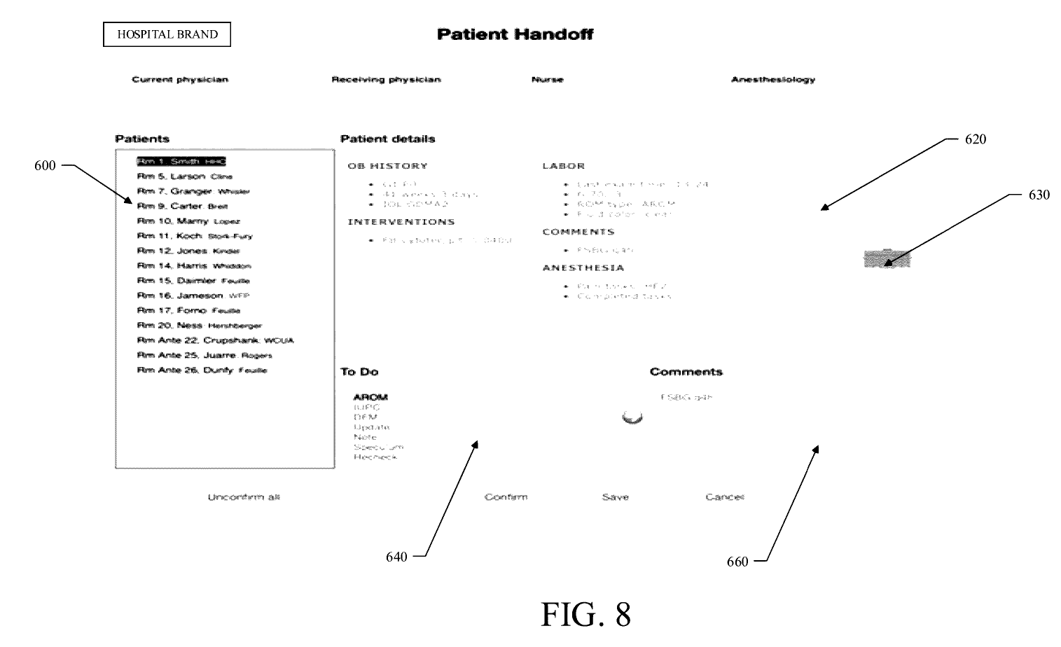

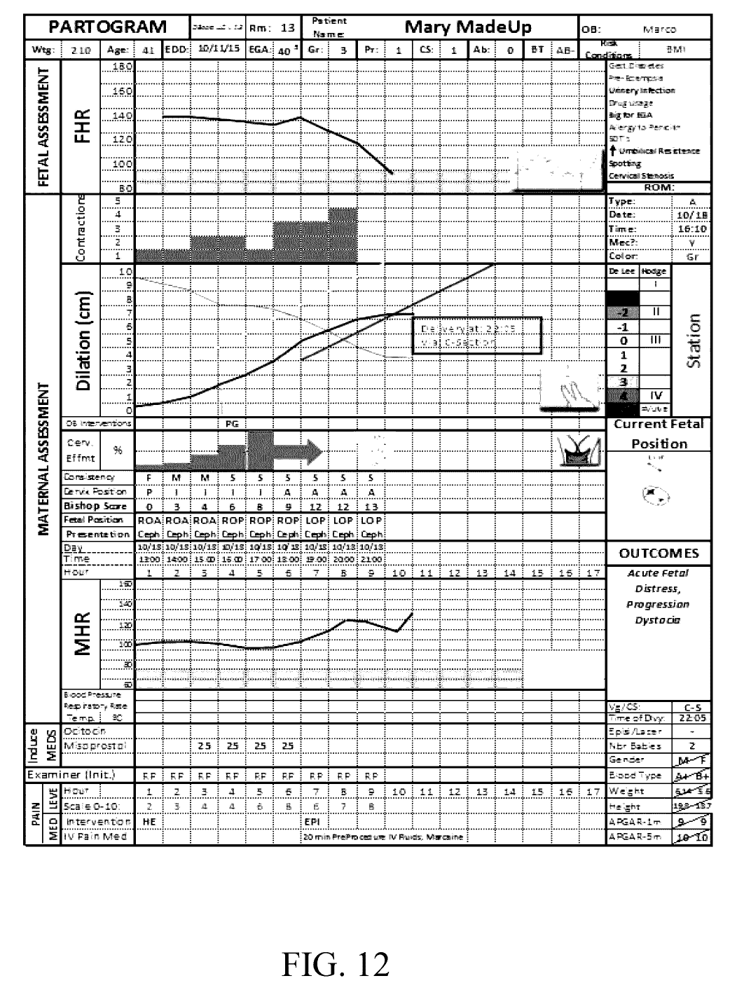

FIG. 8 illustrates an example embodiment of the user interface generated by the healthcare workflow manager 44 in response to the user 64 selecting the handoff option 500. By selecting the handoff option 500, the staff member (i.e., user 64) transitioning to care may review the data associated with the patient profile (such as patient conditions, medical interventions, progress of labor, or the like) in a graphical display, with all related notes and planned care that was going to be implemented by the subsequent staff. As shown in FIG. 8, the healthcare workflow manager 44 may cause a first portion 600 of the user interface 60 to display a list of patients that are being transitioned to the user 64. In response to the user 64 selecting one of the patients displayed on the first portion 600 of the user interface 60, the healthcare workflow manager 44 may cause the user interface 60 to display a snapshot view of the patient profile 120 on a second portion 620 of the user interface 60. Additionally, in response to the user 64 selecting a partogram option 630, the healthcare workflow manager 44 may generate a graphical labor progression curve associated with the patient profile 120, which is discussed in more detail below (see FIG. 12). Moreover, in some cases, the healthcare workflow manager may populate a to-do list associated with the patient on a third portion 640 of the user interface 60. The to-do list may be automatically generated via the healthcare workflow manager 44 or may be entered manually via the exiting staff member. In even further example embodiment, any comments made by the previous staff member may be displayed on a fourth portion 660 of the user interface 60.

In further example embodiments, the healthcare workflow manager 44 may cause the display of a notepad to appear on the user interface 60. In some cases, the notepad may be overlaid on the healthcare facility profile 100 and may be selectable and movable via the user 64 to any location on the user interface 60. The user 64 may select the notepad in order to enter notes as desired. Moreover, upon the selection of a category 140, the healthcare workflow manager 44 may cause the notepad, with user comments if any, to be displayed on the user interface displaying the data associated with the category 140.

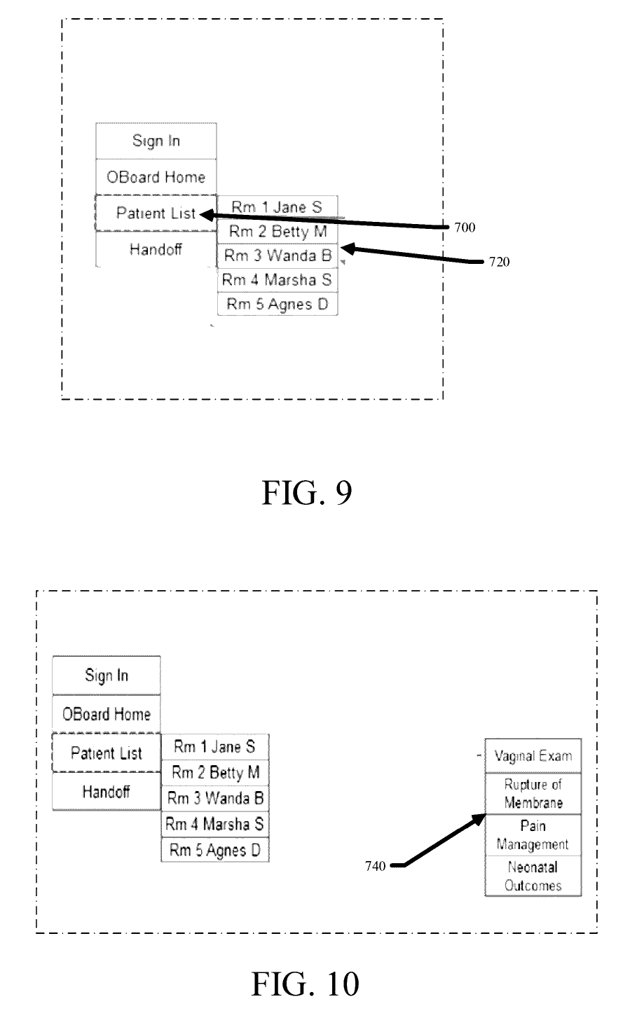

FIGS. 9-11 illustrate further example embodiments of the display of a plurality of patient profiles on the user interface in accordance with another example embodiment contained herein. In some cases, FIGS. 9-11 illustrate an example user interface of the plurality of patient profiles on a mobile device of the user.

As shown in FIG. 9, the healthcare workflow manager 44 may cause to be displayed on a user interface a patient list option 700. In response to selection of the patient list option 700, the healthcare workflow manager 44 may cause to be displayed a list of patient names 720 for which a patient profile 120 exists. In some cases, in addition to displaying the patient name 720, the healthcare manger may cause the display of the patient name 720 in conjunction with the assigned room number. As shown in FIG. 10, in response to selection of a patient name 720, the healthcare workflow manager 44 may cause the display of categories 740 associated with the patient profile 120 (e.g., vaginal exam, ROM, pain management, neonatal outcomes, or the like).

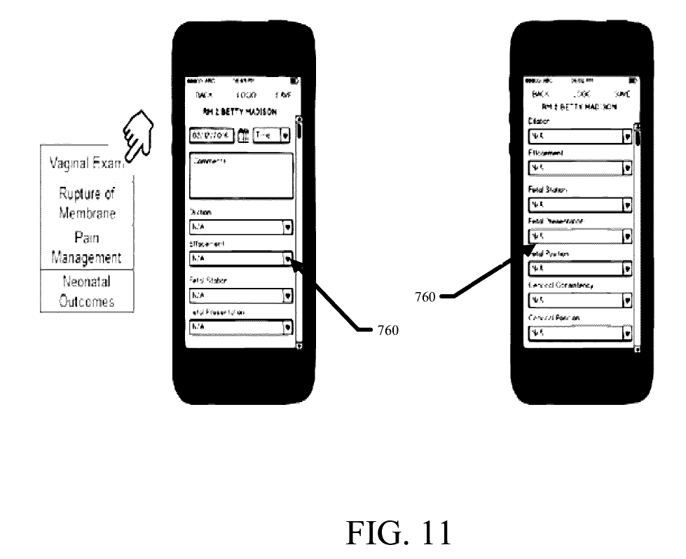

As shown in FIG. 11, in response to selection of a category 740 (e.g., vaginal exam), the healthcare workflow manager may cause a plurality of predefined options 760 to be displayed on the user interface 60. As previously discussed, by generating pre-defined options (in the form of drop-down menus or the like), the healthcare workflow manager 44 enables the healthcare professional to improve their speed, accuracy, completeness, and consistency of data input. This results in the following: less chance of entering errors; formalized critical thinking from following known decision-tree options; and increased ability to analyze data consistently over-time and between facilities.

Based on the data in the patient profile 120, the healthcare workflow manager 44 may be configured to generate charts and provide recommended actions to the user 64. In some cases, in response to the user selecting the category 140 titled “partogram” in the patient profile 120, the healthcare workflow manager 44 may generate a partogram based on the data currently entered in the patient profile 120. FIG. 12 illustrates an example embodiment of the user interface generated in response to the user selecting the “partogram” category. The partogram may graphically show delivery progress data (e.g., progression trend information for dilation and station) and the vital signs data for the patient and baby. Moreover, the healthcare workflow manager 44 may be configured to generate generalized standard labor progression curves on the partogram. In some cases, the healthcare workflow manager may only be configured to generate generalized standard labor progression curves in response to data in the patient profile 120 indicating that dilation has reached 6 cm.

In some cases, in response to selecting the category titled “partogram”, the healthcare workflow manager 44 may not only display the partogram based on the current data in the patient profile 120 but may also cause the display of individualized expected labor progression curves based on an algorithm of historical data of patients with similar medical profiles. By showing both the current and expected progression of labor, the user 64 may more efficiently manage and analyze the labor and delivery process of the patient. In some cases, the partogram displayed in response to the selection of the “partogram” category may include at least one of: 1) patient's actual labor progression curve, which is generated by the healthcare workflow manager 44 based on the data in the patient profile 120; 2) a generalized standard labor progression curve, which is generated by the healthcare workflow manager 44 based on industry standard labor progression curves; and 3) an individualized expected labor curve, which is generated by the healthcare workflow manager based on an algorithm which factors in the stored data associated with other patient profiles that the healthcare workflow manager 44 may have determined to have a similar medical profile to the patient. For example, in generating the individualized expected labor curve, the healthcare workflow manager 44 may determine, based on data contained in stored patient profiles 120, which patients have similar medical profile, history, conditions, prior pregnancies, or the like and use the data from those patient profiles 120 (who have already given birth) to generate a curve of the expected labor progression of the current patient.

In accordance with other example embodiments, the healthcare workflow manager 44 may be configured to calculate the Bishop's score for graphically displaying on the user interface 60 in response to selection by the user 64. The Bishop's score may aid in determining whether or when to induce labor. In some cases, the Bishop's score may be displayed as a portion of the partogram.

In accordance with other example embodiments, the healthcare workflow manager 44 may apply various algorithms to the data in the patient profile 120 to calculate, among other thing, gestational age of the fetus. Furthermore, an algorithm may be used that integrates data such as patient age, body weight, ethnicity, medications, conditions, medical history, prior pregnancies, estimated gestational age, and stage of labor to chart a graph demonstrating individualized expected labor progression.

The health manager 44 may also be configured to provide numerous recommended actions based on the data in the patient profile 120. In one example embodiment, the healthcare workflow manager 44 may provide reminders to perform an updated examination on the patient. For example, if the healthcare workflow manager 44 determines a predefined time has passed since receiving data indicating an examination of the patient has been performed, the healthcare workflow manager 44 may provide reminders to perform an examination of the patient. In other words, if one hour has passed since the last examination of the patient, the healthcare workflow manager 44 may provide reminders to conduct a new examination of the patient. In a further example embodiments, such as when data indicates that medication has been administered to the patient, the healthcare workflow manager 44 may provide reminders to, after a predetermined amount of time has passed since receiving data that indicates a dose of medication has been given, that an additional dose of the medication be administered to the patient.

In accordance with other example embodiments contained herein, the healthcare workflow manager 44 may also be configured to generate reports for staff assessments and quality assessment. These reports may include individual assessments, department assessments, and resident experience reports. For example, a user 64 may be able to track all patient profiles in which they were the assigned doctor, nurse, etc. Moreover, the healthcare workflow manager 64 may be able to extract information from the patient profiles on which the user 64 was assigned in order to become or remain board certified. Additionally, by generating these reports, healthcare facilities may improve quality of care and outcomes, increase workflow efficiency, and increase oversight, training, and risk management of healthcare professionals.

In some example embodiments, the healthcare workflow manager 44 may be configured to interact with and gather data from other healthcare workflow managers 44 associated with other healthcare facilities. This data may be de-identified and used to generate clinical analytics reports. Clinical analytics reports may include any report used to support the quality and improvement efforts of the healthcare facility and the overall labor and delivery process for future patients. For example, the healthcare workflow manager 44 may be configured to gather data and generate a clinical analytics report for an accurate assessment of the caesarian section rate and the factors identified for electing the caesarian section.

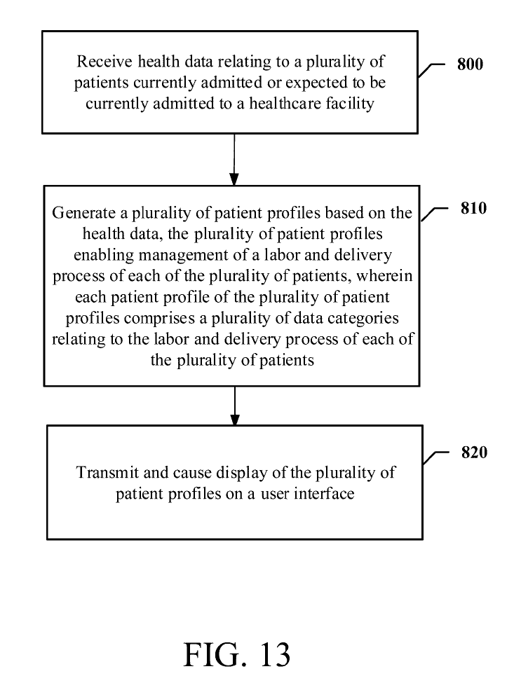

As an example, FIG. 13 is a flowchart of an example method according to example embodiments of the invention. It will be understood that each block of the flowchart, and combinations of blocks in the flowchart, may be implemented by various means, such as hardware, firmware, processor, circuitry or other device associated with execution of software including one or more computer program instructions. For example, one or more of the procedures described above may be embodied by computer program instructions. In this regard, the computer program instructions which embody the procedures described above may be stored by a memory device of a user terminal and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, FIG. 13 is a method according to an example embodiment. The method may be employed by a healthcare workflow manager 44. The method may include, receiving health data relating to a plurality of patients currently or expected to be admitted to a healthcare facility, at operation 800. At operation 810, the method may further include generating a plurality of patient profiles based on the health data, the plurality of patient profiles enabling management of a labor and delivery process of each of the plurality of patients, wherein each patient profile of the plurality of patient profiles comprises a plurality of data categories relating to the labor and delivery process of each of the plurality of patients. At operation 820, the method may further include transmitting and causing display of the plurality of patient profiles on a user interface.

Accordingly, a healthcare workflow manager may be provided that includes processing circuitry configured to receive health data relating to a plurality of patients currently admitted or expected to be currently admitted to a healthcare facility. The processing circuitry may be further configured to generate a plurality of patient profiles based on the health data, the plurality of patient profiles enabling management of a labor and delivery process of each of the plurality of patients, where each patient profile of the plurality of patient profiles includes a plurality of data categories relating to the labor and delivery process of each of the plurality of patients. The processing circuitry may be even further configured to transmit and cause display of the plurality of patient profiles on a user interface.

The healthcare workflow manager may include various modifications, additions or augmentations that may optionally be applied. Thus, for example, in some cases, each data category of the plurality of data categories of each patient profile of the plurality of patient profiles may be individually selectable by a user. Alternatively or additionally, in response to the selection of the data category by the user, the processing circuitry may be configured to generate a detailed view of the data category on the user interface. Alternatively or additionally, in response to generating the detailed view of the data category, the processing circuitry may be further configured to generate drop-down options or pop-up menus regarding the data category in order to receive additional health data relating to the data category via manual user input. Alternatively or additionally, in response to the selection of the data category by the user, the processing circuitry may be configured to generate a graphical representation of the patient profile on the user interface. In some cases, the graphical representation of the patient profile may be a partogram. Alternatively or additionally, the processing circuitry may be further configured to provide reminders to a user based on the plurality of patient profiles. Alternatively or additionally, the processing circuitry configured to provide reminders may include being configured to alert that one of the plurality of patients is due for an examination or medical intervention. Alternatively or additionally, the data categories may include at least one of the following categories: a consulting physician, a number of previous pregnancies, a number of successful deliveries, an estimated gestational age, conditions, a delivery time, a delivery route, a last examination time, dilation, an effacement, a fetal station, a rupture of membrane type, a fluid observation, interventions, or pain management options. Alternatively or additionally, the health data may be received via manual user input or from a sensor or system associated with the healthcare facility. Alternatively or additionally, the sensor or system is any one of an electronic medical records system, a thermometer, a blood pressure monitor, a maternal or fetal heart rate monitor, or contraction monitor. Alternatively or additionally, the processing circuitry may be further configured to generate clinical analytics reports based on the plurality of patient profiles. Alternatively or additionally, the processing circuitry may be further configured to generate a snapshot view of each of the plurality of patients to facilitate a transition of care.

Many modifications and other embodiments will come to mind to one skilled in the art to which this disclosure pertains having the benefit of the teachings presented in the foregoing descriptions and the associated drawings. Therefore, it is to be understood that this disclosure is not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A healthcare workflow manager comprising processing circuitry configured to:
receive health data relating to a plurality of patients currently admitted or expected to be currently admitted to a healthcare facility;
generate a plurality of patient profiles based on the health data, the plurality of patient profiles enabling management of a labor and delivery process of each of the plurality of patients, wherein each patient profile of the plurality of patient profiles comprises a plurality of data categories relating to the labor and delivery process of each of the plurality of patients; and
transmit and cause display of the plurality of patient profiles on a user interface.

2. The healthcare workflow manager of claim 1, wherein each data category of the plurality of data categories of each patient profile of the plurality of patient profiles is individually selectable by a user.

3. The healthcare workflow manager of claim 2, wherein in response to the selection of the data category by the user, the processing circuitry is configured to generate a detailed view of the data category on the user interface.

4. The healthcare workflow manager of 3, wherein in response to generating the detailed view of the data category, the processing circuitry is further configured to generate drop-down options or pop-up menus regarding the data category in order to receive additional health data relating to the data category via manual user input.

5. The healthcare workflow manager of claim 2, wherein in response to the selection of the data category by the user, the processing circuitry is configured to generate a graphical representation of the patient profile on the user interface.

6. The healthcare workflow manager of claim 5, wherein the graphical representation of the patient profile is a partogram.

7. The healthcare workflow manager of claim 1, wherein the processing circuitry is further configured to provide reminders to a user based on the plurality of patient profiles.

8. The healthcare workflow manager of claim 7, wherein the processing circuitry configured to provide reminders includes being configured to alert that one of the plurality of patients is due for an examination, medical intervention, or monitoring.

9. The healthcare workflow manager of claim 1, wherein the data categories comprise at least one of the following categories: a consulting physician, a number of previous pregnancies, a number of successful deliveries, an estimated gestational age, conditions, a delivery time, a delivery route, a last examination time, dilation, an effacement, a fetal station, a rupture of membrane type, a fluid observation, interventions, or pain management options.

10. The healthcare workflow manager of claim 1, wherein the health data is received via manual user input or from a sensor or system associated with the healthcare facility.

11. The healthcare workflow manager of claim 10, wherein the sensor or system is any one of an electronic medical records system, a thermometer, a blood pressure monitor, a maternal or fetal heart rate monitor, or contraction monitor.

12. The healthcare workflow manager of claim 1, wherein the processing circuitry is further configured to generate clinical analytics reports based on the plurality of patient profiles.

13. The healthcare workflow manager of claim 1, wherein the processing circuitry is further configured to generate a snapshot view of each of the plurality of patients to facilitate a transition of care.

14. A method comprising:
receiving health data relating to a plurality of patients currently admitted or expected to be currently admitted to a healthcare facility;
generating a plurality of patient profiles based on the health data, the plurality of patient profiles enabling management of a labor and delivery process of each of the plurality of patients, wherein each patient profile of the plurality of patient profiles comprises a plurality of data categories relating to the labor and delivery process of each of the plurality of patients; and
transmitting and causing display of the plurality of patient profiles on a user interface.

15. The method of claim 14, wherein each data category of the plurality of data categories of each patient profile of the plurality of patient profiles is individually selectable by a user.

16. The method of claim 15, wherein in response to the selection of the data category by the user, the method further comprising generating a detailed view of the data category on the user interface.

17. The method of claim 17, wherein in response to generating the detailed view of the data category, the method furthering comprising generating drop-down options or pop-up menus regarding the data category in order to receive additional health data relating to the data category via manual user input.

18. The method of claim 15, wherein in response to the selection of the data category by the user, the method further comprising generating a graphical representation of the patient profile on the user interface.

19. The method of claim 18, wherein the graphical representation of the patient profile is a partogram.

20. The method of claim 14, further comprising providing recommended actions to a user based on the plurality of patient profiles.
